(19) United States
(12) Patent Application Publication
(10) Pub. No.: US 2022/0021888 A1
(43) Pub. Date: Jan. 20, 2022

(54) SYSTEMS AND METHODS TO ENCODE REGIONS-OF-INTEREST BASED ON VIDEO CONTENT DETECTION

(71) Applicant: Alibaba Group Holding Limited, Georgetown (KY)

(72) Inventors: Minghai QIN, Sunnyvale, CA (US); Yen-kuang CHEN, Palo Alto, CA (US); Tae Meon BAE, Sunnuyvale, CA (US); Guanlin WU, Sunnyvale, CA (US); Yuanwei FANG, Sunnyvale, CA (US); Sicheng LI, Sunnyvale, CA (US)

(21) Appl. No.: 16/931,019

(22) Filed: Jul. 16, 2020

(51) Int. Cl. H04N 19/167; H04N 19/17; H04N 19/146; G06K 9/00; H04N 19/136; A63F 13/822; A63F 13/52

(52) U.S. Cl. CPC H04N 19/167; H04N 19/17; H04N 19/146; G06K 9/00718; G06K 2209/27; H04N 19/136; A63F 13/822; A63F 13/52; G06K 9/00744

(57) ABSTRACT

Video coding techniques including variable bitrate encoding based on regions-of-interest (ROIs) and the type of the video content, the type of sets of frames of the video content, the type of scenes of the video content, or the like.

### BACKGROUND OF THE INVENTION

Numerous techniques are used for reducing the amount of data consumed by the transmission or storage of video. One common technique is to use variable bitrate encoding of video frame data. For example, a first bitrate can be utilized to encode one or more regions-of-interest (ROIs), and a second bitrate can be utilized to encode one or more non-ROIs. Referring to FIG. 1, an exemplary video frame image is illustrated. The portion of the frame that contains a rifle scope view may be more important than the rest of the frame that generally contains the background. A ROI 110 about the rifle scope view may be specified by a bounding box 120, with the remainder of the video being non-region-of-interest 130. The detected ROI 110 can be encoded with a higher bitrate, so that the image of the rifle scope view will have a better image quality than the non-region-of-interest 130 portion of the image that is encoded with a lower bitrate. The variable bitrate encoding can improve the subjective video quality while reducing the amount of data consumed by the transmission or storage of the video.

The detection of ROIs and variable bitrate encoding of ROIs and non-ROIs can be computationally intensive. Therefore, the increased computational intensity of detecting ROIs can reduce the application of variable bitrate encoding in streaming video. In addition, it can be difficult to adjust the variable bitrate encoding. Accordingly, there is a continuing need for improved variable bitrate encoding of video images.

### SUMMARY OF THE INVENTION

The present technology may best be understood by referring to the following description and accompanying drawings that are used to illustrate embodiments of the present technology directed toward systems and methods to encode regions-of-interest (ROIs) based on video content detection.

In one embodiment, a video processing unit can include a content detection engine, a ROI generator, a rate controller and a video encoder. The content detection engine can be configured to receive input video content and determine a content type of the input video content or content type of one or more portions of the input video content. The ROI generator can be configured to receive an indication of a content type of the input video content or one or more portions of the input video content and select one or more predetermined regions of the input video content or one or more portions of the input video content as one or more ROIs based on the content type of the input video content or content type of the one or more portions of the input video content. The rate controller can be configured to receive the one or more ROIs and determine a first encoder rate for the one or more ROIs and a second encoder rate for one or more non-ROIs of the corresponding video frames. The video encoder can be configured to receive the input video content, the one or more ROIs and the one or more non-ROIs, and the first and second encoder rates, and generate a compressed bit stream of the input video content using the first encoder rate for the one or more ROIs and the second encoder rate for the one or more non-ROIs.

In another embodiment, a video processing unit can include a content detection engine, a ROI generator and a rate controller. The content detection engine can include a frame sampler configured to sample sets of frames or scenes of the input video content. The content detection engine can further include a scene classifier configured to determine the content type of each set of frames or each scene. The ROI generator can be configured to receive an indication of the content type of each set of frames or each scene the input video content and select one or more predetermined regions of a corresponding video frame as one or more ROIs based on the determined content type. The rate controller can be configured to receive indications of the one or more ROIs and determine a first encoder rate for the one or more ROIs and a second encoder rate for one or more non-ROIs.

In yet another embodiment, a method of video processing can include detecting a content type of a given portion of video content. One or more ROIs for a given portion of video content can be generated based on the content type of the given portion of the video content. A first encoding rate can be determined for the one or more ROIs, and a second encoding rate can be determined for one or more non-ROIs of the given portion of the video content. The one or more ROIs can be encoded at the first encoding rate and the one or more non-ROIs can be encoded at the second encoding rate, for each corresponding portion of the video stream to generate a compressed bitstream.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Embodiments of the present technology are illustrated by way of example and not by way of limitation, in the figures of the accompanying drawings and in which like reference numerals refer to similar elements and in which:

FIG. 1 illustrates an exemplary video frame image.

FIG. 2 shows a block diagram of a video processing unit, in accordance with aspects of the present technology.

FIG. 3 shows a flow diagram of a video processing method, in accordance with aspects of the present technology.

FIG. 4 shows a block diagram of a video processing unit, in accordance with aspects of the present technology.

FIG. 5 illustrates an exemplary vide frame image.

FIG. 6 shows a block diagram of an exemplary computing system configured for video processing unit, in accordance with aspects of the present technology.

FIG. 7 shows a block diagram of an exemplary processing core, in accordance with aspects of the present technology.

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the technology to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that these terms are to be interpreted as referencing physical manipulations and quantities and are merely convenient labels and are to be interpreted further in view of terms commonly used in the art. Unless specifically stated otherwise as apparent from the following discussion, it is understood that through discussions of the present technology, discussions utilizing the terms such as “receiving,” and/or the like, refer to the actions and processes of an electronic device such as an electronic computing device that manipulates and transforms data. The data is represented as physical (e.g., electronic) quantities within the electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. The use of the terms “comprises,” “comprising,” “includes,” “including” and the like specify the presence of stated elements, but do not preclude the presence or addition of one or more other elements and or groups thereof. It is also to be understood that although the terms first, second, etc. may be used herein to describe various elements, such elements should not be limited by these terms. These terms are used herein to distinguish one element from another. For example, a first element could be termed a second element, and similarly a second element could be termed a first element, without departing from the scope of embodiments. It is also to be understood that when an element is referred to as being “coupled” to another element, it may be directly or indirectly connected to the other element, or an intervening element may be present. In contrast, when an element is referred to as being “directly connected” to another element, there are not intervening elements present. It is also to be understood that the term “and or” includes any and all combinations of one or more of the associated elements. It is also to be understood that the phraseology and terminology used herein is for the purpose of description and should not be regarded as limiting.

Streaming of video content, such as movies and video games, has become very popular. Video encoding is utilized to compress the video content for storage and transmission in video streaming services and other similar applications. Therefore, improved video content compression achieved through variable bitrate encoding for regions-of-interest (ROIs) and non-regions-of-interest (non-ROIs) based the given type of content and/or type of scene of the content can improve system performance.

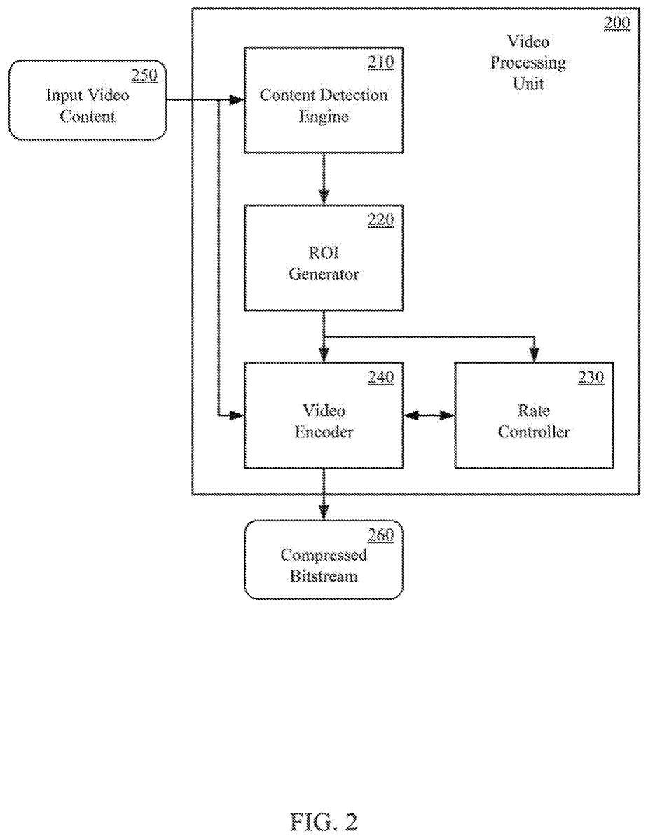

Referring to FIG. 2 a video processing unit, in accordance with aspects of the present technology, is shown. The video processing unit 200 can include a content detection engine 210, a region-of-interest (ROI) generator 220, a rate controller 230 and a video encoder 240. One or more elements of the video processing unit 200 can be implemented in hardware, firmware, computing device-executable instructions (e.g., software) that are stored in computing device-readable media (e.g., computer memory) and executed by a computing device (e.g., processor), or any combination thereof. For example, the content detection engine 210 and ROI generator 220 can be implemented in software executing on one or more processors or one or more cores of one or more processors, while the rate controller 230 and video encoder 240 can be implemented in hardware. In another example, the content detection engine 210, ROI generator 220 and rate controller 230 can be implemented in software executing on one or more processors or one or more cores of one or more processors, while the video encoder 240 can be implemented in hardware.

The content detection engine 210 can be configured to receive input video content 250 and determine a content type of the input video content 250 and or content type of one or more portions of the input video content 250. In one implementation, the video content can be any of a plurality of different types of streaming content including, but not limited to, movies, video games or the like. In one implementation, the content detection engine 210 can determine if the received input video content 250 is a video game, a movie, show or the like. In another implementation, the content detection engine 210 can determine if the received input video content 250 is a particular type of video game, a particular type of movie, a particular type of show or the like. For example, the content detection engine 210 can determine if the received input video content 250 is a first person perspective action video game, a strategy video game, an action/adventure move, a romantic comedy move, a game show or the like. In another implementation, the content detection engine 210 can determine a particular type for a set of frames, a scene, or the like of the received input video content 250. For example, the content detection engine 210 can determine if a given set of frames or a given scene of the received input video content 250 is a wide field of view set of frames for a video game, a set of frames or scene including a magnified scene portion such as a rifle scope view, or the like. In one implementation, the type of the video content can be determined from metadata of the received video content, user inputs during video game play or the like. In another implementation, the video content type and or the various types of scenes can be determined by analyzing the received video content using one or more artificial intelligence models to determine the given type of video content. In one implementation, the content detection engine 210 can be configured to determine how frequently to apply content detection to the input video content 250. In another implementation, the content detection engine 210 can apply content detection at predetermined intervals. Detecting scenes of an input video frame can advantageously be performed with very small latency. For example, detecting the type of a scene or a set of frames in a video can be performed in about 10 milliseconds (ms) on a single thread Xeon processor.

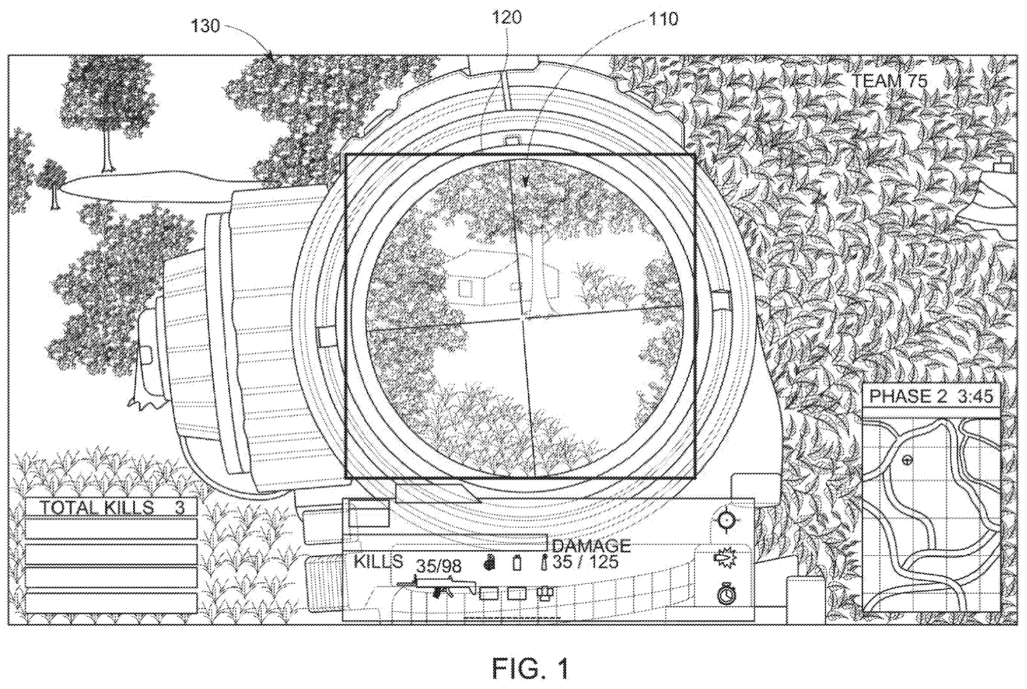

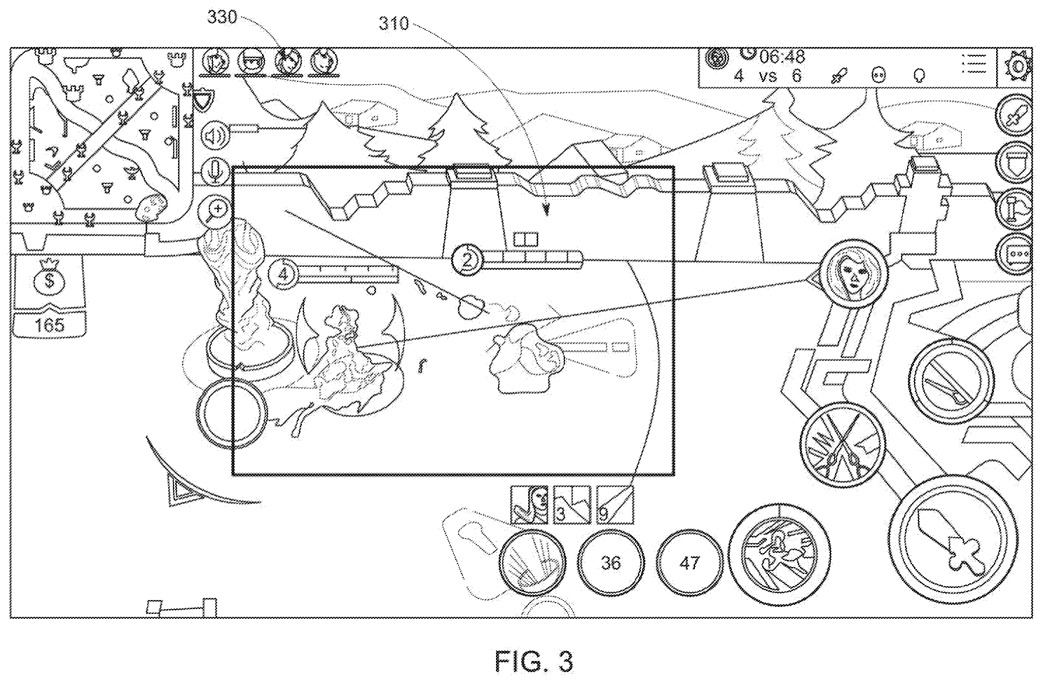

The ROI generator 220 can be configured to receive an indication of a content type of the input video content 250 or one or more portions of the video content 250 from the content detection engine 210. The one or more portions can include sets of frames, scenes, or the like. The ROI generator 220 can be further configured to select one or more predetermined regions of corresponding video frames of the input video content or one or more portions of the input video content as one or more regions-of-interest (ROIs) based on the determined content type. Various content types can be characterized by an intrinsic ROI. The intrinsic ROI can be in a predetermined location and or of a predetermined size in some video content types. In other video content types, the intrinsic ROI can be positioned relative to one or more given features in the video content (e.g., character, avatar, opponent) or associated with features in the video content (e.g., cursor, active icon), and or can be of a predetermined size. In one implementation, a constant region of a video frame can be selected as a ROI for a first content type, and a variable region of a video frame can be selected as a ROI for a second content type. For example, a mid-screen of a constant size can be selected as a ROI 110 for the frames of a first person perspective action type video game, as illustrated in FIG. 1. In a strategy video game, a region about where an active element (e.g., icon) or the like resides in each frame can be selected as a ROI 310, as illustrated in FIG. 3. Those portions of video frames that are not the one or more generated ROIs can be considered non-ROIs 130, 330. Using predetermine locations and or sizes for the ROIs can further reduce the computational latency of video processing.

The rate controller 230 can be configured to receive the one or more determined ROIs and determine one or more encoder bitrates for the one or more determined ROIs and one or more non-ROIs of the frames of the input video steam 250. In one implementation, the rate controller 230 can determine a first encoder bitrate for the one or more determined ROIs and a second encoder bitrate for the one or more non-ROIs of the frames of the input video content 250 to achieve a predetermined video frame bitrate. In another implementation, the rate controller 230 can determine a first encoder bitrate for the one or more determined ROIs and a second encoder bitrate for the one or more non-ROIs of the frames of the input video content 250 to achieve a predetermined video quality. The variable bitrate encoding can improve the subjective video quality while reducing the amount of data consumed by the transmission or storage of the video content.

The video encoder 240 can be configured to receive the input video content 250, one or more indicators of the one or more determined ROIs and optionally one or more non-ROIs, the one or more encoder bitrates for the one or more determined ROIs and one or more non-ROIs of the frames of the input video steam 250, and generate a compressed bit stream 260 therefrom. In one implementation, the video encoder 240 includes an application programming interface to receive the one or more indicators of the one or more determined ROIs, and the one or more encoder bitrates for the one or more determined ROIs and one or more non-ROIs, and to configure the bitrate encoding for the one or more determined ROIs and one or more non-ROIs of the frames of the input video content 250. Applying different bitrates to encoding ROIs and non-ROIs can advantageously achieve a 15-50% bitrate reduction. In addition, one or more encoding parameters, including but not limited target bitrate, frame rate, resolution, largest coding unit (LCU) size, group of picture (GOP) length, number of bidirectional predicted picture (B) frame in GOP, motion search range, intra-coded picture (I), B, and predicted picture (P) frame initial quantization parameter (QP), and bit ratio among I, B and P frames can be adjusted for the one or more determined ROIs and one or more non-ROIs.

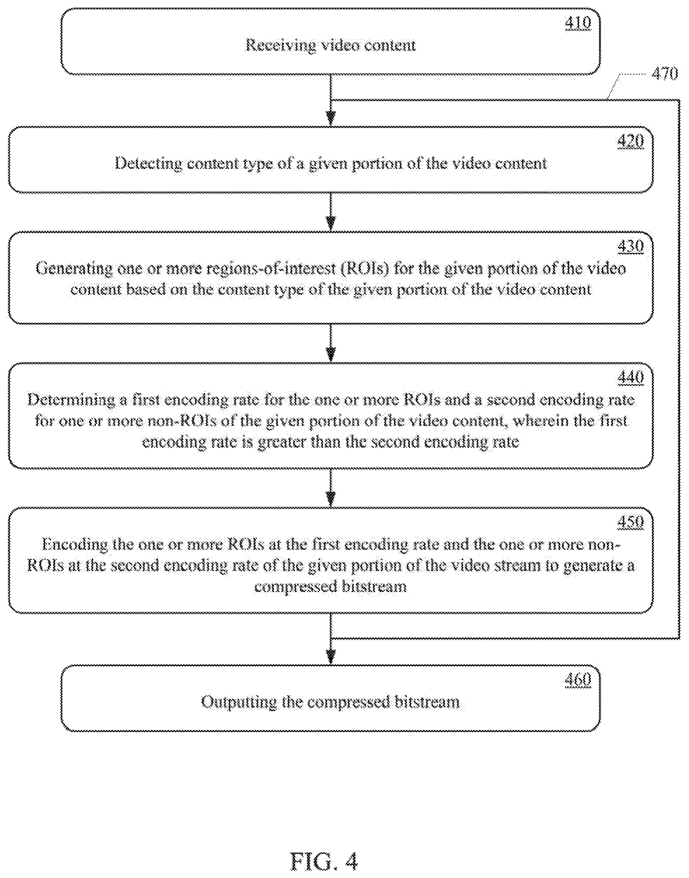

Referring now to FIG. 4, a video processing method, in accordance with aspects of the present technology, is shown. The method can include receiving an input video content, at 410. In one implementation, the video content can be any of a plurality of different types of streaming content including, but not limited to, movies, video games or the like. At 420, the content type of the input video content or a given portion of the input video content can be determined. In one implementation, it can be determined if input video content is a video game, a movie, show or the like. In another implementation, the type of scene of the given portion of the input video content can be determined. For example, a set of frames or scene of the input video content can be determined to be a wide field of view set of frames for a first person shooter video game, and another set of frames or scene can be determined to include a magnified scene portion, such as a rifle scope view. In a strategy video game, portions of a set of frames or scene can be determined to correspond to a current position of a cursor icon. In one implementation, the type of the video content and or types of the various scenes of the video content can be determined from metadata of the input video content and or from user inputs. In another implementation, the video content type and or the various types of scenes can be determined by analyzing the received video content using one or more artificial intelligence models to determine the given type of video content or portions thereof.

At 430, one or more ROIs can be generated for the input video content or a given portion of the input video content based on the content type of input video content, set of frames of the video content, scene of the input given content, or other portion of the input video content. In one implementation, a constant region of the video frames of the given portion of the input video content can be selected as a ROI for a first content type, and a variable region of a video frame can be selected as a ROI for a second content type. For example, a mid-screen of a constant size can be selected as a ROI for the frames a first person shooter type video game, while a region about where a cursor icon resides in each frame can be selected as a ROI for a strategy type video game. Those portions of video frames that are not the one or more generated ROIs can be considered non-ROIs.

At 440, a first encoding rate for the one or more ROIs and a second encoding rate for the one or more non-ROIs of the given portion of the video content can be determined. The first encoding rate for the one or more ROIs can be greater than the second encoding rate for the one or more non-ROIs. In one implementation, the first encoder bitrate for the one or more determined ROIs and the second encoder bitrate for the one or more non-ROIs can be selected to achieve a predetermined video frame bitrate. In another implementation, the first encoder bitrate for the one or more determined ROIs and the second encoder bitrate for the one or more non-ROIs can be selected to achieve a predetermined video frame quality.

At 450, the one or more ROIs of the input video content or the given portion of the video content can be encoded at the first encoding rate and the one or more non-ROIs can be encoded at the second encoding rate to generate a compressed bitstream. The processes at 420-450 can be repeated 470 for each portion of the input video content. The compressed bitstream of the input video content or each portion of the input video content can be output, at 460. In one implementation, outputting the compressed bitstream can comprise streaming the compressed bitstream to one or more user on one or more networks as a streaming video service. In another implementation, the compressed bitstream can be stored on one or more computing device-readable media (e.g., computer memory).

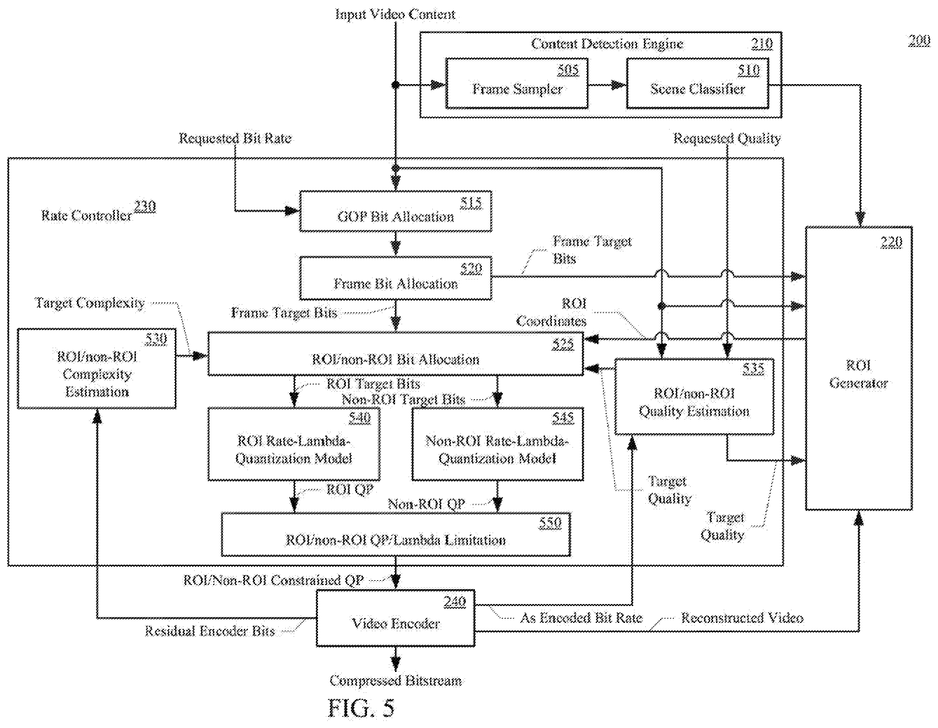

Referring now to FIG. 5, a video processing unit, in accordance with aspects of the present technology, is shown. The video processing unit 200 can include a content detection engine 210, a ROI generator 220, a rate controller 230 and a video encoder 240. The content detection engine 210 can include a frame sampler 505 and a scene classifier 510. The frame sampler 505 can be configured to sample sets of frames or scenes of the input video content. In one implementation, the frame sampler 505 can sample sets as a predetermined number of frames. In another implementation, the frame sampler 505 can determine sets of frames corresponding to each scene of the input video content. For example, the frames of each of a plurality of scenes of the input video content can be determined by the frame sampler 505 from metadata of the received video content. In another example, the frame sampler 505 can include an artificial intelligence model to determine the scenes of the input video content. The scene classifier 510 can be configured to determine the content type of each set of frames or each scene. For example, the scene classifier 510 can determine if a given set of frames or a given scene of the received input video content is a wide field of view set of frames for a video game, a set of frames or scene include a magnified scene portion such as a rifle scope view, a strategy video game includes a cursor icon, or the like. In one implementation, the type of each set of frames or each scene can be determined from metadata of the received video content. In another implementation, the type of each set of frames or each scene can be determined using an artificial intelligence model.

The ROI controller 220 can be configured to receive an indication of the content type of each set of frames or each scene the input video content 250 from the content detection engine 210 and select one or more predetermined regions of a corresponding video frame as one or more ROIs based on the determined content type. In one implementation, a constant region (e.g., location and size) of a video frame can be selected as a ROI for a first content type, and a variable region (e.g., location) of a video frame can be selected as a ROI for a second content type. For example, a mid-screen of a constant size can be selected as a ROI for the frames a first person perspective action type video game, while a region about where a cursor icon corresponding to a given region in each frame can be selected as a ROI for a strategy type video game. Those portions of video frames that are not the one or more generated ROIs can be considered non-ROIs.

The rate controller 230 can include a group of pictures (GOP) bit allocation unit 515 configured to receive a requested bitrate and the input video content. The input video content can include a plurality of video data frames. The group of pictures bit allocation unit 515 can be configured to perform group of pictures (GOP) level bit allocation based on the video data frames and the requested bitrate. A frame bit allocation unit 520, of the rate controller 230, can be configured to perform frame level bit allocation based on the group of picture bit allocation to generate a frame target bit allocation.

A ROI/non-ROI bit allocation unit 525 of the rate controller 230 can be configured to receive coordinates of one or more ROIs determined by the ROI generator 210 and the frame target bit allocation. The ROI/non-ROI bit allocation unit 525 can also be configured to receive target complexity estimates of the one or more ROIs and non-ROI estimated by a ROI/non-ROI complexity estimation unit 530, as described further below. The ROI/non-ROI bit allocation unit 525 can also be configured to receive quality estimations of the one or more ROIs and one or more non-ROIs estimated by a ROI/non-ROI quality estimation unit 535, as described further below. The ROI/non-ROI bit allocation unit 525 can be configured to allocate bits for the one or more determined ROIs and the one or more non-ROIs respectively based on the frame target bit allocation, the coordinates of the one or more determined ROIs, the estimated target complexity of the one or more ROIs and non-ROI, and the estimated target quality of the one or more ROIs and non-ROI. For example, the ROI/non-ROI bit allocation unit 525 can allocate a first bitrate for one or more ROIs and a second bitrate for one or more non-ROIs, wherein the first bitrate is greater than the second bitrate.

A ROI rate-lambda-quantization model unit 540, of the rate controller 230, can receive the ROI target bit allocation from the ROI/non-ROI bit allocation unit 525. The ROI rate-lambda-quantization module unit 540 can be configured to generate quantization parameters (QP) and or rate-distortion-optimization (RDO) parameters for the one or more determined ROIs based on the ROI target bit allocation.

A non-ROI rate-lambda-quantization model unit 545, of the rate controller 230, can receive the non-ROI target bit allocation from the ROI/non-ROI bit allocation unit 525. The non-ROI rate-lambda-quantization module unit 545 can be configured to generate quantization parameters (QP) and or rate-distortion-optimization (RDO) parameters for the one or more non-ROIs based on the non-ROI target bit allocation.

A non-ROI rate-lambda limitation unit 550 can receive the quantization parameters (QP) and or rate-distortion-optimization (RDO) parameters for the one or more determined ROIs and the one or more non-ROIs. The non-ROI rate-lambda limitation unit 550 can be configured to constrain changes in the quantization parameters (QP) and or rate-distortion-optimization (RDO) parameters for the one or more determined ROIs and the one or more non-ROIs to a predetermined rate of change range for quality stability purposes.

The video encoder 240 can receive the constrained quantization parameters (QP) and rate-distortion-optimization (RDO) parameters. The video encoder 240 can be configured to generate a compressed bit stream for the received video frame data based on the constrained quantization parameters (QP) and or rate-distortion-optimization (RDO) parameters. Optionally, the video encoder 240 can be configured to generate the compressed bit stream based on the unconstrainted quantization parameters (QP) and or rate-distortion-optimization (RDO) parameters. The video encoder 240 can also be configured to generate feedback to the ROI/non-ROI complexity estimation unit 530, the ROI/non-ROI quality estimation unit 535, and the ROI generator 210 after encoding a current frame. In one implementation, the video encoder 240 can provide residual encoder bit information to the ROI/non-ROI complexity estimation unit 530. The video encoder 240 can also provide reconstructed video frame data to the ROI/non-ROI quality estimation unit 535. The video encoder 240 can also provide as encoded bitrate information to the ROI generator 220.

The ROI/non-ROI complexity estimation unit 530 can receive residual encoder bit information from the video encoder 240. The ROI/non-ROI complexity estimation unit 530 can be configured to estimate the target complexity of ROIs and non-ROIs based on the residual encoder bits of the previous frames or the current frame. In one implementation, the residual encoder bits can be a mean absolute difference (MAD), a mean square absolute error (MSE), or the like.

In one implementation, the lower bound of bits for the one or more determined ROIs and the non-ROI can be calculated by the ROI/non-ROI bit allocation unit 525 based on the complexity values generated by the ROI/non-ROI complexity estimation unit 530. The frame target bits minus the lower bound of bits for the one or more determined ROIs and the non-ROI is the remaining bits, which can be used to perform the quality control of the one or more ROIs and the non-ROI to reduce the chance of the one or more determined ROIs and non-ROIs from consuming too many bits and cause bit-starving during generation of the compressed bit stream for the next image data frame.

The ROI/non-ROI quality estimation unit 535 can receive requested quality information. The requested quality information can indicate a requested quality for the one or more determined ROIs and a requested quality for the one or more non-ROIs. In one implementation, the requested quality information can be a difference factor between the quality for the one or more determined ROIs and the quality for the one or more non-ROIs. For example, the requested quality can be expressed as a 0 dB, 1 dB, 2 dB, etc. difference between quality for the one or more determined ROIs and the quality for the one or more non-ROIs. The ROI/non-ROI quality estimation unit 535 can be configured to estimate a target quality for the one or more determined ROIs and the one or more non-ROIs based on the requested quality information. The ROI/non-ROI quality estimation unit 535 can also receive the input video source and the reconstructed video from the video encoder 240. The ROI/non-ROI quality estimation unit 535 can be further configured to estimate the target quality for the one or more determined ROIs and the one or more non-ROIs based on the difference between the input video source and the reconstructed video. The target quality for the one or more determined ROIs and the one or more non-ROIs can be output to the ROI and non-ROI bit allocation unit 525, and the ROI generator 220.

In one implementation, the ROI/non-ROI quality estimation unit 535 can be configured to use the feedback information from the video encoder 240 to adjust a weighting of a target bit allocation for the one or more determined ROIs and the non-ROI. In one implementation, if the quality of the one or more determined ROIs is too low for the current (t) frame, more bits can be allocated to the one or more determined ROIs in the next (t+1) frame to upgrade the quality. In one implementation, the quality of a video data frame can be some measure from the original frame and a reconstructed frame, such as the mean absolute difference value (MAD), peak signal-to-noise ratio (PSNR), structural similarity index matric (SSIM), video multimethod assessment fusion (VMAF), or the like. The quality can also be the difference of MAD, PSNR, SSIM, VMAF, or the like.

The ROI generator 220 can receive the frame target bit allocation, the target quality and the as encoded bitrate. The ROI generator 220 can be configured to adjust the one or more determined ROIs and the one or more non-ROIs based on the frame target bit allocation, the target quality and the as encoded bitrate. In one implementation, the size of the one or more determined ROIs can be decreased or increased based on the frame target bit allocation, the target quality and the as encoded bitrate.

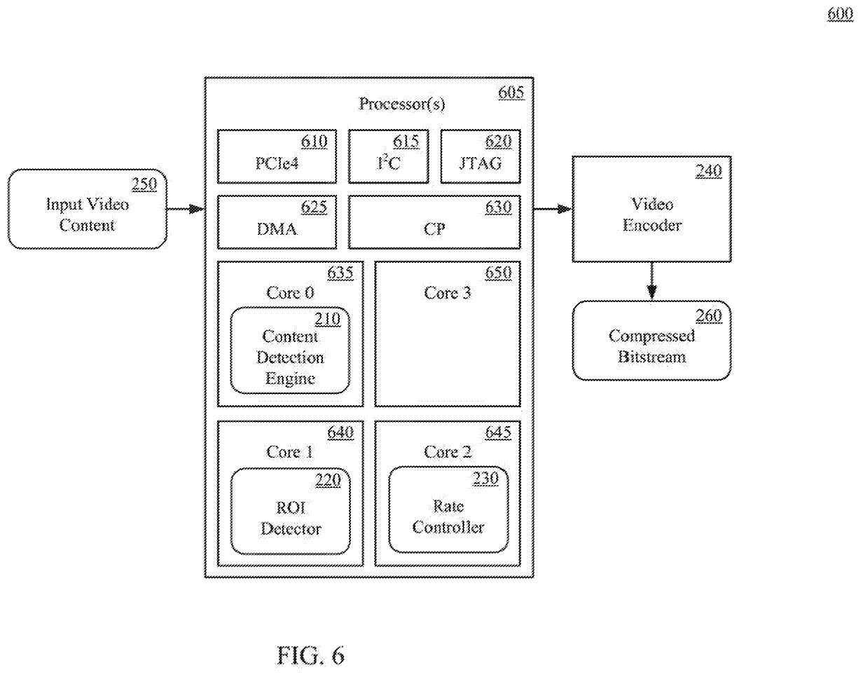

Referring now to FIG. 6, an exemplary computing system configured for video processing unit, in accordance with aspects of the present technology, is shown. The computing system 600 can include one or more processors 605 and one or more video encoders 240. The one or more video encoders 240 can be implemented in separate hardware, or in software executing on the one or more processes 605. In one implementation, the computing system 600 can be a server computer, a data center, a cloud computing system, a stream service system, an internet service provider system, a cellular service provider system, or the like.

The processing unit 605 can include one or more communication interfaces, such as peripheral component interface (PCIe4) 610 and inter-integrated circuit (I²C) interface 615, an on-chip circuit tester, such as a joint test action group (JTAG) engine 620, a direct memory access engine 625, a command processor (CP) 630, and one or more cores 635-650. The one or more cores 635-650 can be coupled in a direction ring bus configuration. The processor unit 605 can be a central processing unit (CPU), a graphics processing unit (GPU), a neural processing unit (NPU), a vector processor, a memory processing unit, or the like, or combinations thereof. In one implementation, one or more processors 605 can be implemented in a computing devices such as, but not limited to, a cloud computing platform, an edge computing device, a server, a workstation, a personal computer (PCs), or the like.

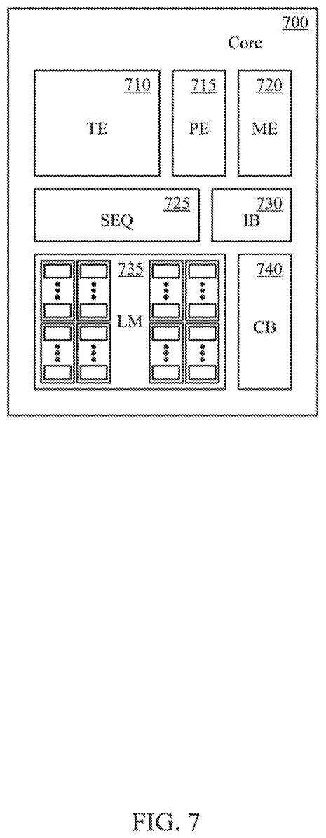

Referring now to FIG. 7, a block diagram of an exemplary processing core, in accordance with aspects of the present technology, is shown. The processing core 700 can include a tensor engine (TE) 710, a pooling engine (PE) 715, a memory copy engine (ME) 720, a sequencer (SEQ) 725, an instructions buffer (IB) 730, a local memory (LM) 735, and a constant buffer (CB) 740. The local memory 735 can be pre-installed with model weights and can store in-use activations on-the-fly. The constant buffer 740 can store constant for batch normalization, quantization and the like. The tensor engine 710 can be utilized to accelerate fused convolution and or matrix multiplication. The pooling engine 715 can support pooling, interpolation, region-of-interest and the like operations. The memory copy engine 720 can be configured for inter- and or intra-core data copy, matrix transposition and the like. The tensor engine 710, pooling engine 715 and memory copy engine 720 can run in parallel. The sequencer 725 can orchestrate the operation of the tensor engine 710, the pooling engine 715, the memory copy engine 720, the local memory 735, and the constant buffer 740 according to instructions from the instruction buffer 730. The processing unit core 700 can provide video coding efficient computation under the control of operation fused coarse-grained instructions for functions such as region-of-interest detection, bitrate control, variable bitrate video encoding and or the like. A detailed description of the exemplary processing unit core 700 is not necessary to an understanding of aspects of the present technology, and therefore will not be described further herein.

Referring again to FIG. 6, the one or more cores 635-650 can execute one or more sets of computing device executable instructions to perform one or more functions including, but not limited to, content detection, region-of-interest generation, rate control and video encoding as described above. The one or more functions 210-230 can be performed on individual core 635-650, can be distributed across a plurality of cores 635-650, can be performed along with one or more other functions on one or more cores, and or the like.

Aspects of the present technology can advantageously utilize variable bitrate encoding to improve the subjective video quality while reducing the amount of data consumed by the transmission or storage of the video. Aspects of the present technology can advantageously determine constant or variable ROIs based on the type of video content, type of sets of frames of the video content, type of scenes of the video content, or the like. Variable bitrate encoding of constant or variable ROIs based on the type of video content can advantageously provide a 15-50% bitrate reduction for content such as video games. The bitrate reduction can be particularly advantageous for streaming video game content, which can account for approximately 20% or more of the content on streaming services. The detection of the content type of the scenes, sets of frames, or the entire video content can advantageously be performed with little computational intensity. In addition, the use of predetermined constant or variable ROIs based on the type of video content can further advantageously reduce the computation intensity of variable bitrate encoding.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

1. A video processing unit comprising:
a content detection engine configured to receive input video content and to determine a content genre of the input video content or content genre of one or more portions of the input video content;
a region-of-interest (ROI) generator configured to receive an indication of the content genre of the input video content or one or more portions of the input video content and to select one or more predetermined regions of corresponding video frames of the input video content or one or more portions of the input video content as one or more ROIs based on the content genre of the input video content or content genre of the one or more portions of the input video content;
a rate controller configured to receive the one or more ROIs and to determine a first encoder rate for the one or more ROIs and a second encoder rate for one or more non-ROIs of the corresponding video frames; and
a video encoder configured to receive the input video content, the one or more ROIs and the one or more non-ROIs, and the first and second encoder rates, and to generate a compressed bit stream of the input video content using the first encoder rate for the one or more ROIs and the second encoder rate for the one or more non-ROIs.

2. The video processing unit of claim 1, wherein the content detection engine is configured to determine the content genre from metadata of the input video content.

3. The video processing unit of claim 1, wherein content detection engine is configured to determine the content genre using one or more artificial intelligence models.

4. The video processing unit of claim 1, wherein the one or more ROIs can be in a predetermined location.

5. The video processing unit of claim 1, wherein the one or more ROIs can be a predetermined size.

6. The video processing unit of claim 1, wherein the one or more ROIs can be positioned relative to one or more given features of the input video content.

7. The video processing unit of claim 1, wherein the first encoding rate is greater than the second encoding rate.

8. The video processing unit of claim 1, wherein the input video content comprises video game content.

9. The video processing unit of claim 8, wherein:
a first content genre comprises a first person perspective action video game; and
a second content genre comprises a strategy video game.

10. A video processing unit comprising:
a content detection engine including,
a frame sampler configured to sample sets of frames or scenes of input video content; and
a scene classifier configured to determine a content genre of each set of frames or each scene;
a region-of-interest (ROI) generator configured to receive an indication of the content genre of each set of frames or each scene of the input video content and to select one or more predetermined regions of a corresponding video frame as one or more ROIs based on the determined content genre; and
a rate controller configured to receive indications of the one or more ROIs and to determine a first encoder rate for the one or more ROIs and a second encoder rate for one or more non-ROIs.

11. The video processing unit of claim 10; further comprising:
a video encoder configured to generate a compressed bit stream based on the first encoder rate for the one or more ROIs and the second encoder rate for the one or more non-ROIs of corresponding sets of frames or scenes.

12. The video processing unit of claim 10, wherein the first encoding rate is greater than the second encoding rate.

13. The video processing unit of claim 10, wherein:
the one or more ROIs are in a predetermined location for a first content genre; and
the one or more ROIs are in a variable location for a second content genre.

14. The video processing unit of claim 13, wherein the variable location comprises a position relative to one or more given features in the input video content.

15. The video processing unit of claim 13, wherein:
the first content genre includes first person perspective action video games; and
the second content genre comprises strategy video games.

16. A method of video processing comprising:
detecting a content genre of a given portion of video content;
generating one or more regions-of-interest (ROIs) for the given portion of the video content based on the content genre of the given portion of the video content;
determining a first encoding rate for the one or more ROIs and a second encoding rate for one or more non-ROIs of the given portion of the video content; and
encoding the one or more ROIs at the first encoding rate and the one or more non-ROIs at the second encoding rate of the given portion of the video content to generate a compressed bitstream.

17. The method according to claim 16, wherein the first encoding rate is greater than the second encoding rate.

18. The method according to claim 16, further comprising:
streaming the compressed bitstream.

19. The method according to claim 16, wherein the video content comprises video game content.

20. The method according to claim 19, wherein:
a first content genre of video content includes a first person perspective action video game; and
a second content genre of video content includes a strategy video game.

21. The method according to claim 20, wherein:
the one or more ROIs are in a predetermined location for a first content genre; and
the one or more ROIs are in a location relative to one or more given features in the video content for a second content genre.
